(19) United States
(12) Patent Application Publication
(10) Pub. No.: US 2020/0334682 A1
(43) Pub. Date: Oct. 22, 2020

(54) FACE PAYMENT DEVICE, FACE PAYMENT METHOD, FACE PAYMENT SYSTEM, AND MACHINE-READABLE STORAGE MEDIUM

(71) Applicant: BEIJING BAIDU NETCOM SCIENCE AND TECHNOLOGY CO., LTD., Beijing (CN)

(72) Inventor: Jiamei Kang, Beijing (CN)

(21) Appl. No.: 16/851,726

(22) Filed: Apr. 17, 2020

(30) Foreign Application Priority Data
Apr. 19, 2019 (CN) 201910319713.7

(51) Int. Cl. G06Q 20/40; G06K 9/00

(52) U.S. Cl. CPC G06Q 20/40145; G06K 9/00288; G06K 9/00255

(57) ABSTRACT

Embodiments of the present disclosure provide a face payment device, a face payment method, a face payment system and a machine-readable storage medium. The face payment device includes a first facial information recognition unit, a second facial information recognition unit, and a payment unit. The second facial information recognition unit is configured to receive first facial information of one or more persons in a place, and compare the first facial information with a pre-stored public database to obtain first identity information that matches the first facial information. The second facial information recognition unit is configured to receive second facial information of persons waiting for payment at a payment spot, and compare the second facial information with the first identity information to obtain second identity information that matches the second facial information. The payment unit is configured to perform a transaction based on the second identity information and a payment instruction.

### CROSS-REFERENCE TO RELATED APPLICATIONS

This application is based on and claims priority to Chinese Patent Application No. 201910319713.7, filed with the State Intellectual Property Office of P. R. China on Apr. 19, 2019, the entire contents of which are incorporated herein by reference.

### TECHNICAL FIELD

The present disclosure relates to the field of face payment, and more particularly, to a face payment device, a face payment method, a face payment system, and a machine-readable storage medium.

### BACKGROUND

Face payment or face recognition payment is an emerging payment method in recent years. When the user pays, he/she only needs to face the camera on a payment terminal, and the system will associate facial information of the user with his/her personal account for deduction, the transaction process is fast and convenient.

### SUMMARY

Embodiments of the present disclosure provide a face payment device, which includes a first facial information recognition unit, a second facial information recognition unit, and a payment unit. The second facial information recognition unit is configured to receive first facial information of one or more persons in a place, and compare the first facial information with a pre-stored public database to obtain first identity information that matches the first facial information. The second facial information recognition unit is configured to receive second facial information of persons waiting for payment at a payment spot, and compare the second facial information with the first identity information to obtain second identity information that matches the second facial information. The payment unit is configured to perform a transaction based on the second identity information and a payment instruction.

Embodiments of the present disclosure provide a face payment method, which includes: receiving first facial information of one or more persons in a place, and comparing the first facial information with a pre-stored public database to obtain first identity information that matches the first facial information; receiving second facial information of persons waiting for payment at a payment spot, and comparing the second facial information with the first identity information to obtain second identity information that matches the second facial information; and performing a transaction based on the second identity information and a payment instruction.

Embodiments of the present disclosure further provide a face payment system, including a face payment device, an auxiliary camera, and a main camera. The auxiliary camera is configured to acquire first facial information of one or more persons in a place, and send the first facial information to a first facial information recognition unit in the face payment device. The main camera is configured to acquire second facial information of persons at a payment spot, and send the second facial information to a second facial information recognition unit in the face payment device.

Other features and advantages of the embodiments of the present disclosure will be described in detail in the following detailed implementations.

### BRIEF DESCRIPTION OF THE DRAWINGS

The accompanying drawings are used to provide a further understanding of the embodiments of the present disclosure, and constitute a part of the description. Together with the following implementations, the accompanying drawings are used to explain the embodiments of the present disclosure, rather than to limit the embodiments of the present disclosure, in which:

FIG. 1 is a schematic diagram of a face payment process according to some embodiments of the present disclosure.

FIG. 2 is a schematic diagram of a screenshot of a payment device according to some embodiments of the present disclosure.

FIG. 3 is a schematic diagram of a face payment device according to some embodiments of the present disclosure.

FIG. 4 is a schematic diagram of a payment unit of a face payment device according to some embodiments of the present disclosure.

FIG. 5 is a schematic diagram of a face payment method according to some embodiments of the present disclosure.

FIG. 6 is a schematic diagram of a face payment system according to some embodiments of the present disclosure.

FIG. 7 is a schematic diagram of illustrating a position of a camera in a face payment system according to some embodiments of the present disclosure.

Reference numerals of the accompanying drawing:

1. auxiliary camera

2. main camera

### DETAILED DESCRIPTION

The specific implementations of the embodiments of the present disclosure will be described in detail below with reference to the drawings. It should be understood that the specific implementations described herein are only used to illustrate and explain the embodiments of the present disclosure, and are not intended to limit the embodiments of the present disclosure.

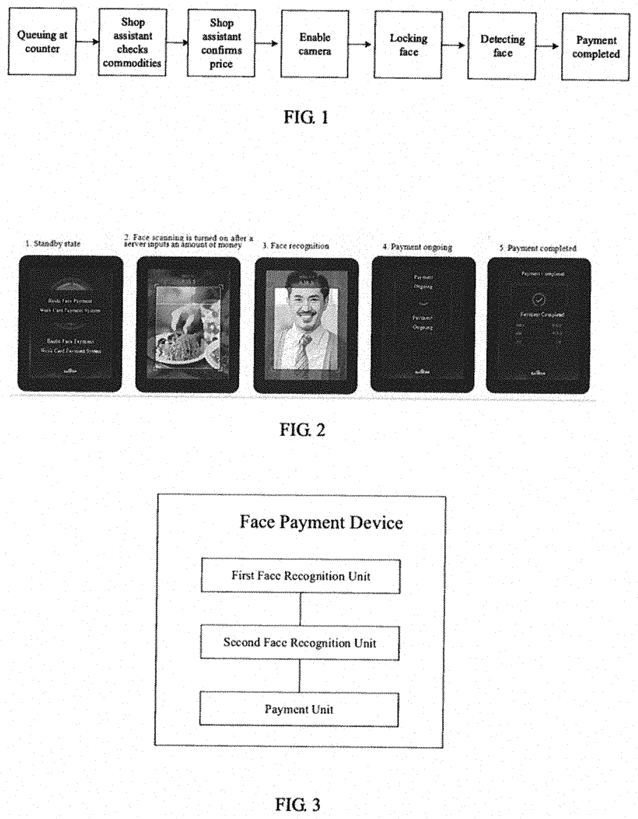

Depending on payment terminals, currently face payments combined with offline payment scenarios can be divided into two categories: user-side face payment (face payment with mobile phone) and merchant-side face payment (with a tablet computer as the main terminal medium). The user-side face payment is often combined with mobile phone code scanning, after the amount is obtained by scanning the code, the user looks at the screen of the mobile phone to scan his/her face with the front camera to make the payment. The use environment of face payment with the mobile phone is private and secure, and it requires to enable the face payment function of the payment product on the user's mobile phone. However, compared with password payment or fingerprint payment, the process of face payment is relatively long, and the user needs to bring and take out his/her mobile phone during the payment process, which has no obvious advantage. FIG. 1 is a schematic diagram of a face payment process in the related art, and FIG. 2 is a schematic diagram of a screenshot of a payment device in the related art. With reference to FIG. 1 and FIG. 2, for merchant-side face payment, it usually requires to connect an external device that supports face scanning at the payment point for the merchant, to allow the user to performs face payment after the amount is obtained. Alternatively, a self-service face checkout machine is provided, and the camera on the machine captures the face in front to confirm the identity of the user when the user scans the QR (Quick Response) code on the goods for entry. Compared with the machine, the cost of the external device is low, the access flexibility is high, so and the penetration rate is high.

The merchant-side face payment may have following advantages. When shopping, the users usually need to check goods or other actions with their hands, by using the merchant-side device for face payment, the users' hands can be freed, and the users do not need to bring the mobile phone with them, and biometric technology is more secure. Moreover, for merchants, face payment can release manpower, the efficiency is improved, and costs can be saved in the long run.

However, the merchant-side face payment has following disadvantages. The use environment is open and complicated, when there are many people in the queue or the network environment is unstable, users may feel stressed, and the waiting time is long. Moreover, during use, in order to ensure that the camera on the device obtains the face that meets quality standards, the users need to adjust the posture, just like looking themselves in the mirror in a public environment, which causes certain psychological pressure to the users. Further, during user, face scanning and payment are performed at the same time, there may be wrong scanning or wrong payment.

FIG. 3 is a schematic diagram of a face payment device according to some embodiments of the present disclosure. As shown in FIG. 3, the face payment device may include a first facial information recognition unit, a second facial information recognition unit, and a payment unit. The first facial information recognition unit and the second facial information recognition unit are configured to receive facial information provided by an external camera. The first facial information recognition unit is configured to receive first facial information of one or more persons in a place, and compare the first facial information with a pre-stored public database, and obtain first identity information that matches the first facial information, thereby determining identity information of the one or more persons in the place in advance. The second facial information recognition unit is configured to receive second facial information of persons waiting for payment at a payment spot, and obtain second identity information that matches the second facial information from the first identity information based on the second facial information. The payment unit is configured to perform a transaction based on the second identity information and a payment instruction.

In some embodiments, after the first facial information of one or more persons in the place is compared with the pre-stored public database, the first facial information recognition unit is further configured to establish a temporary database based on the first identity information that matches the first facial information. The temporary database includes the identity information of the persons entering the place. The second facial information recognition unit may be configured to compare the second facial information with the temporary database, and obtain the second identity information corresponding to the second facial information. Since the data amount of the temporary database is much smaller than the data amount of the public database, the efficiency of determining the second identity information of the persons at the payment spot can be improved.

After the payment unit completes a transaction, it may send transaction feedback information to the first facial information recognition unit. The transaction feedback information may include the identity information code identity information in the transaction order. The first facial information recognition unit may be configured to delete the first identity information corresponding to the identity information code in the temporary database after a set time based on the received transaction feedback information. In this way, after invalid identity information in the temporary database is cleared in real time, the efficiency of the second facial information recognition unit in determining the identity information of the persons at the payment spot can be improved.

In the case where the ranking information of the persons waiting for payment at the payment spot changes, the second facial information recognition unit may be configured to compare the facial information of the plurality of persons with the temporary database updated in real time based on the first identity information of all the persons in the place, and obtain the identity information of the actual persons waiting for payment at the payment spot, so as to update the identity information of the persons waiting for payment at the payment spot. The change of the ranking information may include that, the original ordering of the plurality of persons waiting for payment changes when the number of persons waiting for payment does not change, and that the number of persons waiting for payment changes, for example, the number of persons waiting for payment in the queue increases, or the number of persons in the queue decreases (for example, the person gives up the purchase).

In order to improve the efficiency of face payment, the payment unit may be configured to pre-establish the pending orders based on ranking information of the persons at the payment spot, and update ranking information of the pending orders accordingly based on the updated ranking information of the persons waiting for payment, after the second facial information recognition unit updates the ranking information of the persons waiting for payment. In some embodiments, the pending order may denote that the order has not been paid, or the order to be paid. Before the transaction is executed, the payment unit may further be configured to display order information to the person currently waiting for payment through a display screen, the order information may include identity information of the person currently waiting for payment and commodity price information. The user may confirm the identity information and commodity price information in the order information displayed by the payment unit, and perform the payment action by clicking the “payment confirm” button on the display screen after confirming that the order information is correct, and then the payment unit may execute the transaction action of the confirmed order information according to the payment instruction of the user. Further, the payment unit may deduct the corresponding amount of money from a preset account (for example, a work card, a pre-purchased electronic shopping card, WeChat account, or other payment accounts) related to the identity information in the order information based on the commodity price.

In the case where the identity information in the order information does not match the person currently waiting for payment, the user may abort the transaction by clicking the “wrong person recognition” button on the display screen of the payment unit, and the payment unit may generate an instruction for updating the ranking information of the persons waiting for payment based on the transaction abortion instruction. The second facial information recognition unit may compare the second facial information of the persons waiting for payment at the payment spot with the temporary database updated in real time to obtain the second identity information that matches the second facial information, and update the ranking information of the persons at the payment spot according to the second identity information that matches the second facial information. The payment unit may update the pending order based on the second identity information of the persons waiting for payment after the ranking information is updated, and execute the transaction process based on the updated pending order, i.e., to perform the transaction (payment) after the user confirms that the order is correct.

When the identity information of a person is not obtained after the first face recognition unit compares the facial information of the persons waiting for payment at the payment spot with the public database, the person may be determined as a temporary person, and the temporary person may be numbered such as L0001, and the facial information and number information of the temporary person may be stored in the temporary database. The second face recognition unit may compare the received second facial information of the persons waiting for payment at the payment spot with the temporary database, and obtain the second identity information of the persons waiting for payment at the payment spot. According to the comparison result with the temporary database, when it is determined that the person currently waiting for payment is a temporary person, since the temporary person does not have pre-stored account, other payment manners such as WeChat payment may be jumped.

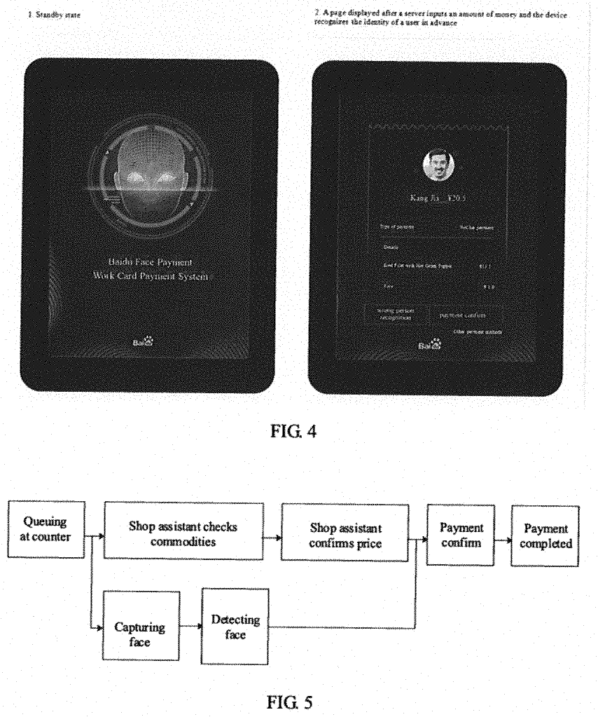

In some embodiments, the face recognition device may be provided in an employee canteen of Baidu. The face recognition device may include the first face recognition unit, the second face recognition unit, and the payment unit. In detail, the first face recognition unit is configured to receive the first facial information of all persons entering the place (i.e., the employee canteen), and compare the first facial information of all persons in the place with the pre-stored public database to obtain the first identity information that matches the first facial information, i.e., to obtain the identity information of all persons in the place. The first face recognition unit is further configured to establish the temporary database based on the obtained first identity information. The second face recognition unit is configured to receive the second facial information of persons waiting for payment at the payment spot. For example, there are five persons in the payment line waiting for payment, the second face recognition unit may receive the second facial information of the five persons, and compare the second facial information with the temporary database to obtain the second identity information of the five persons waiting for payment. The payment unit may be configured to establish, according to the second identity information of the five persons and their ranking information, pending orders in the same ranking or sorting. In the case where one of the five persons gives up the purchase and leaves the payment line, the second face recognition unit may receive the change in the number of persons in the payment line, and determine that the order of the persons waiting for payment at the payment spot (i.e., the ranking information changes) changes. The second face recognition unit may compare the second facial information of the remaining four persons waiting for payment at the payment spot with the temporary database to obtain the second identity information corresponding to the actual persons waiting for payment at the payment spot, so as to update the second identity information determined previously. The payment unit may update the previously established pending orders based on the updated second identity information of the remaining four persons waiting for payment at the payment spot, such that the ranking of the updated pending orders is the same as the ranking of the persons waiting for payment at the payment spot. During the transaction process, as shown in FIG. 4, which illustrates a payment unit of a face payment device according to some embodiments of the present disclosure, the payment unit may display the order information to the person currently waiting for payment through a display screen, the order information includes the identity information of the person currently waiting for payment (employee name and/or employee number) and the name and price of the purchased products (for example, beef filet with hot green pepper*1 ¥19.5, rice*1 ¥1.0). When the user confirms that the order information is correct, he/she may click the “payment Confirm” button on the display screen to make the payment. The payment unit may execute the transaction action of the confirmed order information based on the payment instruction from the user. In an example, the payment unit may deduct the corresponding amount from the work card related to the identity information in the order information based on the commodity price.

In the case where the identity information in the order information does not match the person currently waiting for payment, the user may abort the transaction by clicking the “wrong person recognition” button on the display screen of the payment unit. The payment unit may generate the instruction for updating the ranking information of the persons waiting for payment based on the transaction abortion instruction. The second facial information recognition unit may compare the second facial information of the persons waiting for payment with the temporary database updated in real time to obtain the second identity information that matches the second facial information, and update the sequence or ranking information of the previously determined second identity information according to the second identity information. The payment unit may update the pending orders based on the second identity information of the persons waiting for payment after the sequence or ranking information is updated, and execute the transaction process based on the updated pending order, i.e., to perform the transaction (payment) after the user confirms that the order is correct.

According to the above technical solutions, the first facial information recognition unit receives the first facial information of one or more persons in the place, and compares the first facial information with the pre-stored public database to obtain the first identity information matching the first facial information, such that the identity information of the persons entering the place is obtained in advance. The second facial information recognition unit receives the second facial information of the persons waiting for payment at the payment spot, and maps the second facial information to the first identity information, so as to obtain the second identity information corresponding to the second facial information. The payment unit executes the transaction based on the second identity information and the user payment instruction. Consequently, the user is free from waiting in the line for face recognition, embarrassing problem of taking photos in public places can be and avoided, the face payment rate can be improved.

Embodiments of the present disclosure further provides a face payment method. In some embodiments, the method may include the following acts. The first facial information of one or more persons in the place is received, the first facial information is compared with the pre-stored public database to obtain the first identity information that matches the first facial information. In this way, the identity information of the one or more persons in the place is determined in advance. Then, second facial information of the persons waiting for payment at the payment spot is received, second identity information that matches the second facial information is obtained from the first identity information determined in advance based on the second facial information. The transaction is executed based on the determined second identity information and the payment instruction.

After the first facial information of one or more persons in the place is compared with the pre-stored public database, a temporary database may be established based on the first identity information. The temporary database includes the identity information of the persons entering the place. The second facial information may be compared with the temporary database to obtain the second identity information. Since the data amount of the temporary database is much smaller than the data amount of the public database, the efficiency of determining the second identity information of the persons at the payment spot can be improved.

In the case where the ranking information of the persons waiting for payment at the payment spot changes, the facial information of the plurality of persons may be compared with the temporary database updated in real time based on the first identity information of all the persons in the place, and the identity information of the actual persons waiting for payment at the payment spot may be obtained, so as to update the identity information of the persons waiting for payment at the payment spot. The change of the ranking information may include that, the original ordering of the plurality of persons waiting for payment changes when the number of persons waiting for payment does not change, and that the number of persons waiting for payment changes, for example, the number of persons waiting for payment in the queue increases, or the number of persons in the queue decreases (for example, the person gives up the purchase).

In order to improve the efficiency of face payment, the pending orders may be pre-established based on ranking information of the persons at the payment spot, and the ranking information of the persons waiting for payment is updated, ranking information of the pending orders may be updated accordingly based on the updated ranking information of the persons waiting for payment. In some embodiments, before the transaction is executed, the order information may also be displayed to the person waiting for payment through the display screen, the order information may include identity information of the person currently waiting for payment and commodity price information. The user may confirm the identity information and commodity price information in the order information displayed, and perform the payment action by clicking the “payment confirm” button on the display screen after confirming that the order information is correct, and the transaction action of the confirmed order information may be performed based on the payment instruction from the user. Further, the corresponding amount of money may be deducted from the preset account (for example, a work card, a pre-purchased electronic shopping card, WeChat account, or other payment accounts) related to the identity information in the order information based on the commodity price.

In a case where the identity information in the order information does not match the person currently waiting for payment, the user may abort the transaction by clicking the “wrong person recognition” button on the display screen. The instruction for updating the ranking information of the persons waiting for payment may be generated based on the transaction abortion instruction, and the second facial information of the persons waiting for payment at the payment spot may be compared with the temporary database updated in real time, so as to obtain the second identity information that matches the second facial information, and the previously determined sequence or ranking information of the identity information of the person at the payment spot may be updated according to the second identity information. The pending order may be updated based on the updated second identity information, and then the transaction process may be executed based on the updated pending order, to perform the transaction (payment) after the user confirms that the order is correct.

When identity information of a person is not obtained after the facial information of the persons waiting for payment at the payment spot is compared with the public database, the person may be determined as a temporary person, and the temporary person may be numbered such as L0001, and the facial information and number information of the temporary person are stored in the temporary database. The second face recognition unit may compare the received second facial information with the temporary database to obtain the second identity information corresponding to the persons waiting for payment at the payment spot. According to the comparison result with the temporary database, when it is determined that the person currently waiting for payment is a temporary person, since the temporary person does not have the pre-stored account, other payment manners such as WeChat payment may be jumped.

FIG. 5 is a schematic diagram of a face payment method according to some embodiments of the present disclosure. In some embodiments, the face recognition method may be applied in an employee canteen of Baidu. In detail, the first facial information of all the persons entering the employee canteen may be received, and the first facial information may be compared with the pre-stored public database, such that the first identity information that matches the first facial information can be obtained, i.e., the identity information of all the persons in the place is obtained. The temporary database may be established based on the obtained first identity information of all the persons in the place. Then, the second facial information of persons waiting for payment at the payment spot may be received. For example, there are five persons in the payment line waiting for payment, the second facial information of the five persons may be received, and compared with the temporary database to obtain the second identity information of the five persons waiting for payment. The pending orders may be established in the same ranking or sorting based on the second identity information of the five persons waiting for payment and their ranking information. In the case where one of the five persons waiting for payment gives up the purchase, and leaves the payment line, the change in the number of persons in the payment line may be received, and it may be determined that the order of the persons waiting for payment at the payment spot (i.e., the ranking information changes). The second facial information of the remaining four persons waiting for payment at the payment spot may be compared with the temporary database to obtain the second identity information corresponding to actual persons waiting for payment at the payment spot, so as to update the second identity information determined previously. The previously established pending orders may be updated based on the updated second identity information of the remaining four persons waiting for payment at the payment spot, such that the ranking of the updated pending orders is the same as the ranking of the persons waiting for payment at the payment spot. During the transaction process, the payment unit may display the order information corresponding to the person currently waiting for payment, the order information includes the identity information of the person currently waiting for payment (employee name and/or employee number) and the name and price of the purchased product (for example, beef filet with hot green pepper*1 ¥19.5, rice*1 ¥1.0). When the user confirms that the order information is correct, he/she may click the “payment Confirm” button on the display screen to make the payment. The payment unit may execute the transaction action of the confirmed order information based on the payment instruction from the user. In an example, the payment unit may deduct the corresponding amount from the work card related to the identity information in the order information based on the commodity price.

In a case where the identity information in the order information does not match the person currently waiting for payment, the user may abort the transaction by clicking the “wrong person recognition” button on the display screen of the payment unit. The instruction for updating the ranking information of the persons waiting for payment may be generated based on the transaction abortion instruction, and the second facial information of the persons waiting for payment may be compared with the temporary database updated in real time, so as to obtain the second identity information that matches the second facial information, and the sequence or ranking information of the previously determined second identity information may be updated based on the second identity information. The pending order is updated based on the identity information of the persons waiting for payment after the ranking is updated, and the transaction process is executed based on the updated pending order, i.e., the transaction (payment) is executed after the user confirms that the order is correct.

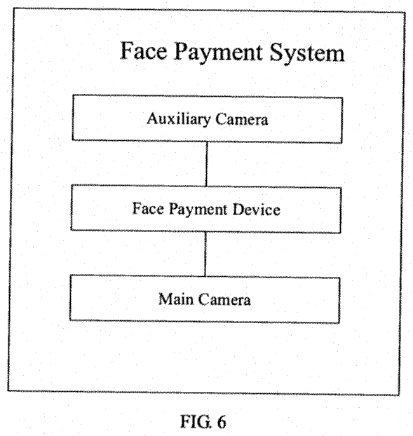

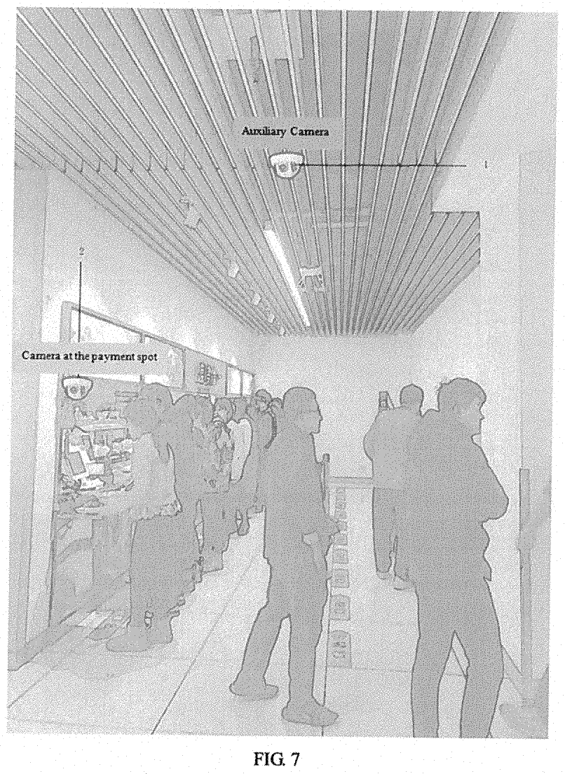

FIG. 6 is a schematic diagram of a face payment system according to some embodiments of the present disclosure. FIG. 7 is a schematic diagram of positions of cameras in a face payment system according to some embodiments of the present disclosure. With reference to FIG. 6 and FIG. 7, the face payment system may include a face payment device as described above, an auxiliary camera 1, and a main camera 2. The auxiliary camera 1 is configured to acquire first facial information of one or more persons in a place, and send the first facial information to the first facial information recognition unit in the face payment device. The auxiliary camera 1 may be installed at a preset position according to needs of the user, for example, the auxiliary camera may be set at the entrance position of the place, so as to collect the first facial information of the persons entering the place in real time, and send the first facial information to the first facial information recognition unit in the face payment device. The main camera 2 is configured to acquire the second facial information of the persons at the payment spot, and send the second facial information to the second facial information recognition unit in the face payment device.

According to requirements of the user or restricted by conditions of the place, the face recognition system may also be provided with only one main camera, the main camera may be set at the payment spot, and configured to acquire the facial information of the persons waiting for payment at the payment spot in advance, and send the acquired facial information to the face recognition device. The face recognition device may compare the received facial information with the pre-stored public database to determine the identity information of the persons waiting for payment at the payment place. In addition, the face recognition device may further compare the facial information of the persons waiting for payment at the payment spot acquired by the main camera 2 in real time with the temporary database, and obtain the identity information that matches the facial infoimation of the persons waiting for payment, and update the ranking information of the previously determined identity information of the persons at the payment spot according to identity information.

The face recognition device includes a processor and a memory. The first face recognition unit, the second face recognition unit and the payment unit are stored in the memory as program units. The processor is configured to execute the program unit stored in the memory to implement the corresponding functions.

The processor includes a kernel, and the kernel retrieves a program unit from the memory. One or more kernels may be provided, and by adjusting parameters of the kernel, the user is free from waiting in line for face recognition, embarrassing problem of taking photos in public places can be and avoided, the face payment rate can be improved.

The memory may include a non-permanent memory, a random-access memory (RAM), and/or a non-volatile memory in the computer readable media, such as a read-only memory (ROM) or a flash memory (flash RAM). The memory includes at least one memory chip.

Embodiments of the present disclosure further provide a storage medium having a program stored thereon. When the program is executed by a processor, the program implements the face recognition method.

Embodiments of the present disclosure further provide a processor for running a program. The face recognition method is executed when the program runs.

Embodiments of the present disclosure further provide a device. The device includes a processor, a memory, and programs stored in the memory and executable by the processor. When the program is executed by the processor, the face payment method according to embodiments of the present disclosure is implemented. The device herein may be a server, a PC, a PAD, a mobile phone, etc.

The present disclosure further provides a computer program product that, when executed on a data processing device, the face payment method according to embodiments of the present disclosure is implemented. The face payment method includes: receiving first facial information of one or more persons in a place, and comparing the first facial information with a pre-stored public database to obtain first identity information that matches the first facial information; receiving second facial information of persons waiting for payment at a payment spot, and comparing the second facial information with the first identity information to obtain second identity information that matches the second facial information; and performing a transaction based on the second identity information and a payment instruction.

In some embodiments, comparing the second facial information with the first identity information to obtain second identity information that matches the second facial information includes: establishing a temporary database based on the first identity information, after comparing the first facial information of the one or more persons in the place with the pre-stored public database; and comparing the second facial information with the temporary database to determine the second identity information corresponding to the persons waiting for payment.

In some embodiments, the method further includes: determining ranking information of the persons waiting for payment based on the second identity information determined; and determining the second identity information of the persons waiting for payment in real time, and updating the ranking information based on the second identity information determined in real time, in a case where the ranking information of the persons waiting for payment changes.

In some embodiments, the method further includes establishing pending orders based on the ranking information updated. The ranking information of the pending orders is updated synchronously with the ranking information of the persons waiting for payment.

In some embodiments, before executing the transaction based on the second identity information and the user payment instruction, the method further includes displaying order information of a person currently waiting for payment. The order information includes identity information of the person currently waiting for payment and commodity price information.

Those skilled in the art will appreciate that embodiments of the present disclosure may be provided as a method, a system, or a computer program product. Accordingly, the present disclosure may take the form of a hardware embodiment, a software embodiment, or an embodiment in combination with software and hardware. Moreover, the present disclosure may take the form of the computer program product that is embodied on one or more computer-usable storage media (including but not limited to disk memories, CD-ROM and optical memories, etc.) including computer-usable program codes.

The present disclosure is described with reference to implementation flowcharts and/or block diagrams of a method, a device (a system) and a computer program product according to embodiments of the present disclosure. It may be understood that each flow and/or block in a flowchart and/or a block diagram, and a combination of a flow and/or a block in a flowchart and/or a block diagram may be implemented by computer program instructions. The computer program instructions may be provided to a processor in a general purpose computer, a special purpose computer, an embedded processor, or other programmable data processing devices to produce a machine, so that instructions executed by a processor in a computer or other programmable data processing devices generate a means configured to implement functions specified in one or more flows in a flowchart and/or one or more blocks in a block diagram.

The computer program instructions may also be stored in a computer readable memory that may instruct a computer or other programmable data processing devices to operate in a particular manner, such that the instructions stored in the computer readable memory produce a manufactured product including an instruction device. The device implements functions specified in one or more flows in a flowchart and/or one or more blocks in a block diagram.

These computer program instructions may also be loaded onto a computer or other programmable data processing devices such that a series of operational steps are performed on a computer or other programmable devices to produce processing implemented by the computer. Consequently, instructions executed on the computer or other programmable devices provide steps for implementing the functions specified in one or more flows in a flowchart and/or one or more blocks in a block diagram.

In a typical configuration, a computing device includes one or more processors (CPUs), input/output interfaces, network interfaces and memories.

The memory may include a non-permanent memory, a random-access memory (RAM), and/or a non-volatile memory in the computer readable media, such as a read-only memory (ROM) or a flash memory (flash RAM). The memory is an example of a computer readable media.

The computer readable media include a permanent, non-permanent, removable and non-removable medium, and the information may be stored by any method or technology. The information may be computer readable instructions, data structures, modules of a program, or other data. Examples of the storage medium of the computer include, but are not limited to, a phase change memory (PRAM), a static random access memory (SRAM), a dynamic random access memory (DRAM), other types of random access memories (RAMS), a read-only memory (ROM), an electrically erasable programmable read-only memory (EEPROM), a flash memory or other memory technologies, a compact disc read-only memory (CD-ROM), a digital versatile disc (DVD) or other optical storage device, a magnetic tape cartridge, a magnetic tape, a magnetic disk storage device or other magnetic storage devices or any other non-transmission media, which can be used to store information that may be accessed by a computing device. As defined herein, the computer readable media do not include temporary computer-readable media (transitory media) such as modulated data signals and carrier waves.

It should also be noted that the terms “comprise”, “include” or any other variations thereof are meant to cover non-exclusive including, so that the process, method, article or device comprising a series of elements do not only comprise those elements, but also comprise other elements that are not explicitly listed or also include the inherent elements of the process, method, article or device. In the case that there are no more restrictions, an element qualified by the statement “includes a . . . ” does not exclude the presence of additional identical elements in the process, method, article or device that includes the said element.

Those skilled in the art will appreciate that embodiments of the present disclosure may be provided as a method, a system, or a computer program product. Accordingly, the present disclosure may take the form of a hardware embodiment, a software embodiment, or an embodiment in combination with software and hardware. Moreover, the present disclosure may take the form of the computer program product that is embodied on one or more computer-usable storage media (including but not limited to disk memories, CD-ROM and optical memories, etc.) including computer-usable program codes.

The above are only embodiments of the present disclosure and are not intended to limit the present disclosure. For those skilled in the art, various modifications and changes may be performed on the present disclosure. Any modification, equivalent replacement and improvement made within the spirit and principle of the present disclosure shall be included in the scope of attached claims of the present disclosure.

What is claimed is:

1. A face payment device, comprising:
a first facial information recognition unit, configured to receive first facial information of one or more persons in a place, and compare the first facial information with a pre-stored public database to obtain first identity information that matches the first facial information;
a second facial information recognition unit, configured to receive second facial information of persons waiting for payment at a payment spot, and compare the second facial information with the first identity information to obtain second identity information that matches the second facial information; and
a payment unit, configured to perform a transaction based on the second identity information and a payment instruction.

2. The face payment device according to claim 1, wherein the second facial information recognition unit is further configured to:
establish a temporary database based on the first identity information, after comparing the first facial information of the one or more persons in the place with the pre-stored public database; and
compare the second facial information with the temporary database to determine the second identity information corresponding to the persons waiting for payment.

3. The face payment device according to claim 1, wherein the second facial information recognition unit is further configured to:
determine ranking information of the persons waiting for payment based on the second identity information determined; and
determine the second identity information of the persons waiting for payment in real time, and update the ranking information based on the second identity information determined in real time, in a case where the ranking information of the persons waiting for payment changes.

4. The face payment device according to claim 3, wherein the payment unit is further configured to:
establish pending orders based on the ranking information updated, wherein ranking information of the pending orders is updated synchronously with the ranking information of the persons waiting for payment.

5. The face payment device according to claim 1, wherein the payment unit is further configured to:
display order information of a person currently waiting for payment, wherein the order information comprises identity information of the person currently waiting for payment and commodity price information.

6. A face payment method, comprising:
receiving first facial information of one or more persons in a place, and comparing the first facial information with a pre-stored public database to obtain first identity information that matches the first facial information;
receiving second facial information of persons waiting for payment at a payment spot, and comparing the second facial information with the first identity information to obtain second identity information that matches the second facial information; and
performing a transaction based on the second identity information and a payment instruction.

7. The face payment method according to claim 6, wherein comparing the second facial information with the first identity information to obtain second identity information that matches the second facial information comprises:
establishing a temporary database based on the first identity information, after comparing the first facial information of the one or more persons in the place with the pre-stored public database; and
comparing the second facial information with the temporary database to determine the second identity information corresponding to the persons waiting for payment.

8. The face payment method according to claim 6, further comprising:
determining ranking information of the persons waiting for payment based on the second identity information determined; and
determining the second identity information of the persons waiting for payment in real time, and updating the ranking information based on the second identity information determined in real time, in a case where the ranking information of the persons waiting for payment changes.

9. The face payment method according to claim 8, further comprising:
establishing pending orders based on the ranking information updated, wherein ranking information of the pending orders is updated synchronously with the ranking information of the persons waiting for payment.

10. The face payment method according to claim 6, wherein the method further comprises:
displaying order information of a person currently waiting for payment, wherein the order information comprises identity information of the person currently waiting for payment and commodity price information.

11. A face payment system, comprising:
a face payment device;
an auxiliary camera, configured to acquire first facial information of one or more persons in a place, and send the first facial information to a first facial information recognition unit in the face payment device; and
a main camera, configured to acquire second facial information of persons at a payment spot, and send the second facial information to a second facial information recognition unit in the face payment device.

12. The face payment system according to claim 11, wherein the face payment device comprises:
the first facial information recognition unit, configured to receive first facial information of one or more persons in a place, and compare the first facial information with a pre-stored public database to obtain first identity information that matches the first facial information;
the second facial information recognition unit, configured to receive second facial information of persons waiting for payment at a payment spot, and compare the second facial information with the first identity information to obtain second identity information that matches the second facial information; and
a payment unit, configured to perform a transaction based on the second identity information and a payment instruction.

13. The face payment system according to claim 12, wherein the second facial information recognition unit is further configured to:
establish a temporary database based on the first identity information, after comparing the first facial information of the one or more persons in the place with the pre-stored public database; and
compare the second facial information with the temporary database to determine the second identity information corresponding to the persons waiting for payment.

14. The face payment system according to claim 12, wherein the second facial information recognition unit is further configured to:
determine ranking information of the persons waiting for payment based on the second identity information determined; and
determine the second identity information of the persons waiting for payment in real time, and update the ranking information based on the second identity information determined in real time, in a case where the ranking information of the persons waiting for payment changes.

15. The face payment system according to claim 14, wherein the payment unit is further configured to:
establish pending orders based on the ranking information updated, wherein ranking information of the pending orders is updated synchronously with the ranking information of the persons waiting for payment.

16. The face payment system according to claim 12, wherein the payment unit is further configured to:
display order information of a person currently waiting for payment, wherein the order information comprises identity information of the person currently waiting for payment and commodity price information.
